(19) United States
(12) Patent Application Publication
(10) Pub. No.: US 2003/0177819 A1
(43) Pub. Date: Sep. 25, 2003

(54) Method of detecting biofilms and residues on medical implants and other devices

(76) Inventor: Gerhard Maale, Dallas, TX (US)

Correspondence Address: David W. Carstens, PO Box 802334, Dallas, TX, 75380-2334, US

(21) Appl. No.: 10/391,520

(22) Filed: Mar. 18, 2003

Related U.S. Application Data
(60) Provisional application No. 60/365,331, filed on Mar. 18, 2002.

(51) Int. Cl. G01B 5/28

(52) U.S. Cl. 73/105

(57) ABSTRACT

A method is disclosed for ensuring a level of sterility and cleanliness that includes recognition of the role of biofilms in chronic infections. Orthopedic hardware, either sterilized from the manufacturer or removed from a patient is examined by a variety of different means to detect biofilms and/or residual debris from the process of manufacturing. The absence of biofilms and debris is certified as a level of cleanliness and sterility above that previously attainable by prior means.

This application claims priority from provisional application 60/365,331, filed Mar. 18, 2002.

### TECHNICAL FIELD OF THE INVENTION

The present invention relates to methods of detecting biofilms and residues on medical implants and other devices. Specifically, the invention relates to multiple methodologies for certifying both the sterility and cleanliness of medical implants, such as artificial hip joints, or other devices, such as probes or tools used in medical procedures.

### BACKGROUND TO THE INVENTION

Ever since the late 19^{th} th century, when Robert Koch's laboratory studies in Germany validated the germ theory of disease, most people, scientists included, have envisioned bacteria as single cells that float or swim through some kind of watery habitat, perhaps part of the human body. This picture emerged from the way investigators usually examine such organisms: by training their microscopes on cultured cells suspended in a fluid droplet. That procedure is convenient but not entirely appropriate, because these experimental conditions do not reflect actual microbial environments. As a result, the bacteria in typical laboratory cultures act nothing like the ones encountered in nature.

In recent years, bacteriologists have gained important insights into how common disease-causing microbes actually live. Many of these organisms do not, in fact, spend much time wafting about as isolated cells. Rather they adhere to various wetted surfaces in organized colonies known as biofilms. These colonies are embedded in a matrix, know as a glyco-calyx, and exist in attachment to nonliving material such as metal prosthesis or dead tissues (but not to living tissue).

These biofilms are complex and tenacious films and the microbes they contain can be nearly impossible to eradicate with conventional antibiotics, causing many very stubborn infections. In the past few years, medical researchers have discovered that the microorganisms in biofilms depend critically on their ability to signal one another. Drugs able to interfere with this transmission might then bar the microbes from establishing infections or undermine their well-fortified positions; such drugs might thus combat maladies ranging from the pneumonia that repeatedly afflicts people with cystic fibrosis to the slow-burning infections that often form around medical implants. However, a need exists immediately for a method of determining whether a biofilm exists on a medical implant in order to avoid its placement in a patient.

Bacterial biofilms are ubiquitous. For example, FIG. 1 illustrates a microscopic view of a contact lens 100 covered with a biofilm that is suspected of causing a corneal infection. The biofilm 102 appears as hardened nodules that under high-powered microscopy form a roughened surface with channels 104. The size of the nodules varies, but is on the order of several microns. Likewise, FIG. 2 provides an image of the biofilm 200 that constitutes dental plaque. Again, the biofilm is formed of elongated nodules 202 separated by channels 204. And bacteria are not alone in the ability to create biofilms. Indeed, the genetic diversity of the microorganisms that can arrange themselves into living veneers indicates that it is an ancient strategy for microbial growth.

Some biologists have attempted to examine the bacteria living in biofilms using ordinary microscopes. They always saw some bacteria, but being unable to obtain clear images from deep within living layers, they concluded that the cells inside were mostly dead and jumbled in random clumps. This view changed little until about a decade ago, when microbiologists began employing a technique called laser scanning confocal microscopy. That technology enables investigators to view slices at different depths within a living biofilm and to stack these planes together to create a three-dimensional representation.

Applying this approach in a concerted effort to study the structure of biofilms, John R. Lawrence of the Canadian National Water Research Institute, Douglas E. Caldwell of the University of Saskatchewan, and Dr. J. W. Costerton of Montana State University demonstrated in 1991 that the bacteria grow in tiny enclaves called micro-colonies. FIGS. 3A to 3E provide an illustration of the formation of such a microcolony. Bacteria 300 themselves generally constitute less than a third of what is there. The rest is a gooey substance 302 the cells secrete, called a glyco-calyx, which invariably absorbs water and traps small particles. This glyco-calyx holds each micro-colony together. A biofilm is built of countless such groupings, separated by a network of open water channels. The fluid coursing through these tiny conduits bathes each congregation of microbes, providing dissolved nutrients and removing waste products. The cells situated on the outside of a micro-colony are well served by this plumbing system, but those in the interior are largely cut off. Both the dense cell aggregation surrounding the interior cells and the organic matrix that cements things together act as barriers to water flow. The cells inside the colony must make do with the nutrients than can diffuse inward to them. The bacteria can send signals via messenger molecules 304 to other bacteria within the biofilm, causing the bacteria to multiply as shown in FIG. 3C. Chemical gradients arise and promote the coexistence of diverse species and metabolic states within the micro-colony. Channels 306 develop, as shown in FIG. 3D. Some cells 300 return to their free-living form and escape. FIG. 3D shows a well-formed microcolony with a network of channels 306.

The variety of chemical environments that arise within a single biofilm means that one cell may look and act very different from the next even when the two are genetically identical. Similarly, local conditions control the production of many toxins and other disease-causing substances by microbial cells in a biofilm; consequently, some cells may inflict little harm on a host, whereas others may be lethal. The wide range of conditions can also permit several bacterial species to live side by side and thrive. Sometimes one species feeds on the metabolic wastes of another, aiding them both.

Biofilms can be a serious threat to health. They can survive most chemical treatments used to control bacteria in medicine and industry, treatments that would quickly eradicate free-floating cells. They can also evade the molecules and cells that the immune system unleashes. Biofilm infections thus tend to be quite persistent and resistant to current antimicrobial treatment.

These biofilms are resilient and at times antibiotics and germ-fighting cleansers may fail to pierce the film. Penicillin antibiotics, for instance, have great difficulty penetrating biofilms containing cells that produce enzymes known as beta-lactamases. These enzymes degrade the antibiotic faster than it can diffuse inward, so that it never reaches the deeper layers of a biofilm. FIG. 4 demonstrates a biofilm 404 that has been treated with chlorine bleach, a favorite of home and industry. Because of the organization of the biofilm, the bleach has a hard time eradicating biofilms 404. This reactive oxidant will eventually burn its way in, but first it must deplete, layer by layer, the neutralizing capacity of the film. That process takes more time and bleach than one might expect. It is easy, therefore, to be lulled into thinking that all bacteria must be dead when many are still alive.

Other factors enhance tenacity as well. Even where an antimicrobial agent penetrates biofilms easily, the microorganisms often still survive aggressive treatment that would eradicate free-floating cells. This ability had long mystified biologists, but lately they have learned that the variety of conditions and bacterial types in a biofilm confers protection against antibacterial agents. Further, physical location enhances the tenacity of a biofilm. For example, FIG. 5 demonstrates a biofilm 502 that has formed in a tiny crevice 503 on a metal implant 504. It is not uncommon for even highly polished implants to have defects as shown that measure one micron in depth.

Many engineers have to contend with the ruinous effects of biofilms in industry, where bacteria often foul machinery and speed the corrosion of metal pipes. For example, FIG. 6 provides an illustration of pipe corrosion 602 caused by biofilm activity. It has been discovered that when bacteria adhere to a surface and form a biofilm, they manufacture hundreds of proteins not found in free-floating cells. It has also been discovered that each cell produces a signaling molecule at a low level. When enough cells assemble, the concentration of these molecules will naturally rise, triggering changes in many of the genes.

FIGS. 7A to 7C provide a view of a number of microbial colonies as seen through a light microscope over a forty-five minute period and illustrates the speed at which a biofilm can form. A stain has been applied that is specific for metabolic activity and will fluoresce when in the presence of such metabolism. The colonies are in an area of fluid flow, as indicated by the arrow in the upper right. The lack of movement of the colonies in the sixteen minutes between FIGS. 7A and 7B illustrate that the microorganisms are attached to the underlying metal surface. By forty-five minutes, as seen in FIG. 7C, the biofilm is actively metabolizing, as evidenced by the fluorescence shown.

Another interesting aspect of biofilms is the gene expression of the bacteria involved. FIGS. 8A and 8B show the proteins produced by P. aeruginosa bacteria, as determined by electrophoresis, which causes the proteins to move at different speeds. FIG. 8A shows the proteins produced in the planktonic state, where it has been determined that the bacteria have only thirty-two (32) active genes. However, in the biofilm state, FIG. 8B, the same bacteria are producing a greater number of proteins, and it has been determined that in this state, they have sixty-four (64) active genes.

More staggering is the intense resistance to antibiotics shown by bacteria in a biofilm state. FIG. 9 demonstrates the impact of an antibiotic, Tobramycin, on both planktonic bacteria and sessile bacteria in a biofilm. In the planktonic bacteria, 10 μg/ml of the antibiotic has slowed, but did not stop the growth of the bacteria. However, with larger dosages of 50 μg/ml or 100 μg/ml of Tobramycin, all bacteria were dead by T=8 hours. In contrast, not even 1000 μg/ml of Tobramycin, a ten-fold increase, could create any meaningful population drop in bacterial count within a biofilm.

FIG. 10 provides some experimental data on oxygen content within a biofilm. In this illustration, the biofilm is approximately 240 microns in depth and 840 microns in width. Oxygen diffusion is greatest near the surface with partial pressure readings for oxygen of 0.142 nm. In the middle, a concentration of 0.010 nm was measured. It is believed that oxygen diffusion limits the growth and shape of the biofilm.

Biofilms that thrive on devices such as urinary catheters and permanent medical implants cause the most worrisome types of biofilm infections, affecting perhaps 10 million people in the U.S. every year. Despite being typically slow to develop, such smoldering infections lead to repeated flare-ups and are extraordinarily difficult to eradicate. Biofilms have also been implicated in periodontal disease, prostate infections, kidney stones, tuberculosis, Legionnaire's disease and some infections of the middle ear.

FIGS. 11 and 12 illustrate the medical implications of biofilms. Numerous foreign devices can be implanted in a patient. This includes curved surfaces 1102, edged surfaces 1104, and screws 1106, as well as the epoxy and other adhesives used to cement the implant in place. The corrosion shown on these devices has been caused by biofilms. A biofilm on the implant can result in inflammation of tissue, an example of which is shown in FIG. 12. In this photograph, an area of bone 1202 projects up from the lower edge of the slide into the central portion. The fibrous tissue 1204 adjacent the bone exhibits the presence of histiocytes, lymphocytes, and vascular proliferation, which are the evidence of chronic inflammation. The chronic inflammation has caused erosion of the bone in an area 1206 adjacent to a suspected biofilm, which is not detectable in the microscopic view of FIG. 12.

Oily residues present on medical implants cause other cases of persistent inflammation in patients. During the manufacturing of metal implants, oil can be used during the milling process. While attempts are made to wash this residue off of the implant, some oil residue can persist. A residue undetected affects the cleanliness of the implant.

In December of 2000, one manufacturer announced a problem with a contaminated lot of acetabular cup prosthesis with oil-based residual. The classic presentation of patient's failure was groin pain on weight bearing with radiolucent halo seen on plain radiographs around the acetabular prosthesis. After pathologic examination of the tissue on H&E preparation (a type of histologic staining—hematoxylin and eosin), there were signs of histiocytic infiltration in the radiolucent zone with a fibrovascular connected tissue interspersed with perivascular lymphocytic infiltration. These failures usually cultured negative, however at the time of revision initially there was approximately a 20% incidence of infection following the revision of the cup. This is 10 times the frequency of infection seen at the time of a normal revision total hip replacement arthroplasty. This information implicates, however, does not prove that infection is a mediator of failures associated with the oil-contamination prostheses.

Given the evolving understanding of the role biofilms play, a need exists for a new definition of sterility and cleanliness in such areas as medical implants. As part of this redefinition, a need also exists for protocols to verify the protocols implemented by the manufacturers of such implants to ensure the sterility and cleanliness of these devices.

### SUMMARY OF THE INVENTION

The present invention addresses the urgent need to detect biofilms and residues on implants before they are placed into patients. Since these devices are produced in large quantities, it also offers a methodology of validating the cleanliness and sterility of such devices.

The present invention recognizes the difficulty of individually inspecting every implanted device for microscopic biofilms. Instead, it focuses on improving and validating the underlying process used by manufacturers in the manufacture and handling of the devices. Further, the present invention recognizes that implants vary in many ways. For example, some have smooth surfaces while others are textured. One means of validating the sterility and cleanliness of a smooth surface will differ from that for a textured surface. Likewise some surfaces are metal while others are synthetic. Thus, a matrix of tests can be conducted that identify with high certainty whether a biofilm might have formed on a particular implant. That matrix can differs according to the shape, material and texture of the implant. However, the basic tests include respirometry, the use of live/dead stains, sonification, scanning electron microscopy, confocal microscopy, and atomic force microscopy.

The present invention is a series of methods focused on reducing the risk of these catastrophic failures. Specifically, the present invention is a matrix of tests that can be performed on various medical devices or implants to detect the presence of biofilms or other residues and consequently validate the sterility and cleanliness of the devices.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIGS. 1 and 2 illustrate biofilms on a contact lens and in dental plaque;

FIGS. 3 and 4 provide a simplified explanation on the life cycle of bacteria forming a biofilm;

FIG. 5 illustrates a biofilm being acted on by a chlorine-based cleaner;

FIG. 6 shows the corrosive effect a biofilm can have on a metal pipe;

FIG. 7 illustrates how bacteria in a biofilm differ in gene activation from bacteria in a flagellum form;

FIG. 8 illustrates changes in protein expression during initial adhesion;

FIG. 9 is a chart showing the increases resistance to antibiotics of bacteria in a biofilm;

FIG. 10 shows dissolved oxygen gradients measured in a biofilm;

FIG. 11 shows the corrosive effect a biofilm can have on a medical implant;

FIG. 12 illustrates the inflammation caused by a biofilm to a patient from the cup portion of a hip implant;

FIG. 13 clearly illustrates a biofilm on a screw used with medical implants;

FIG. 14 shows a biofilm formed on cement used with a medical implant;

FIG. 15 is an illustration of the various shapes and textures encountered on medical implants and devices;

FIG. 16 is a flowchart illustrating the conditions for sterility and cleanliness;

FIG. 17 is a flowchart detailing the methodology of detecting a biofilm;

FIG. 18 is a flowchart detailing the methodology of detecting a residue; and

FIGS. 19 and 20 illustrate the effectiveness of ELISA in detecting biofilms.

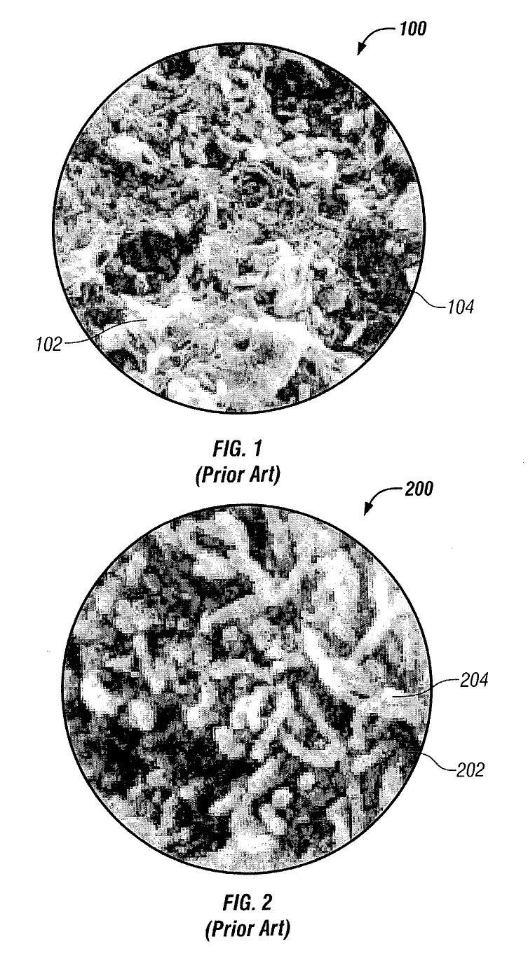

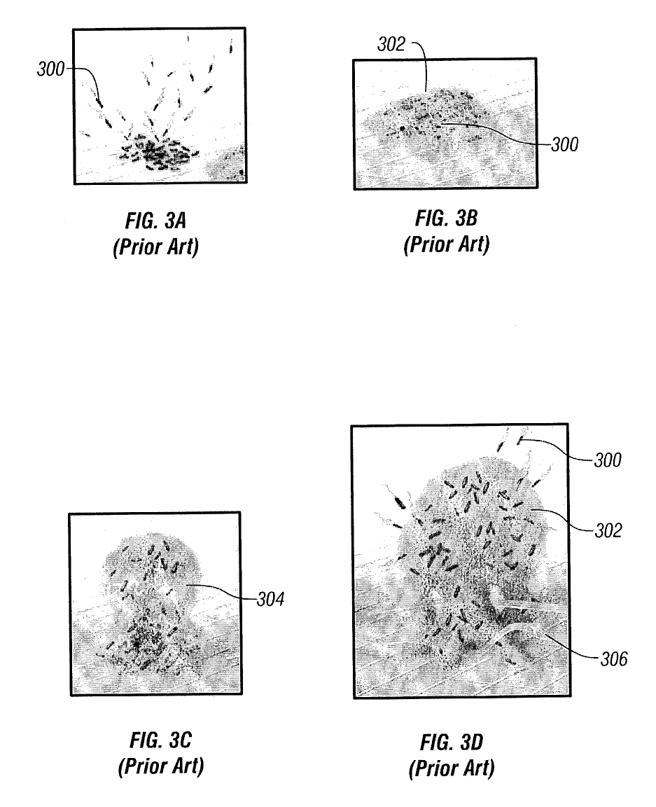

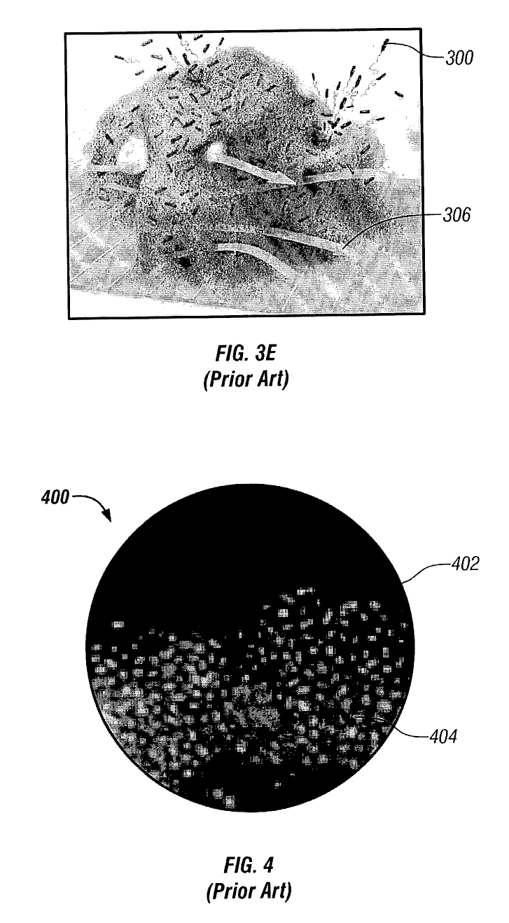

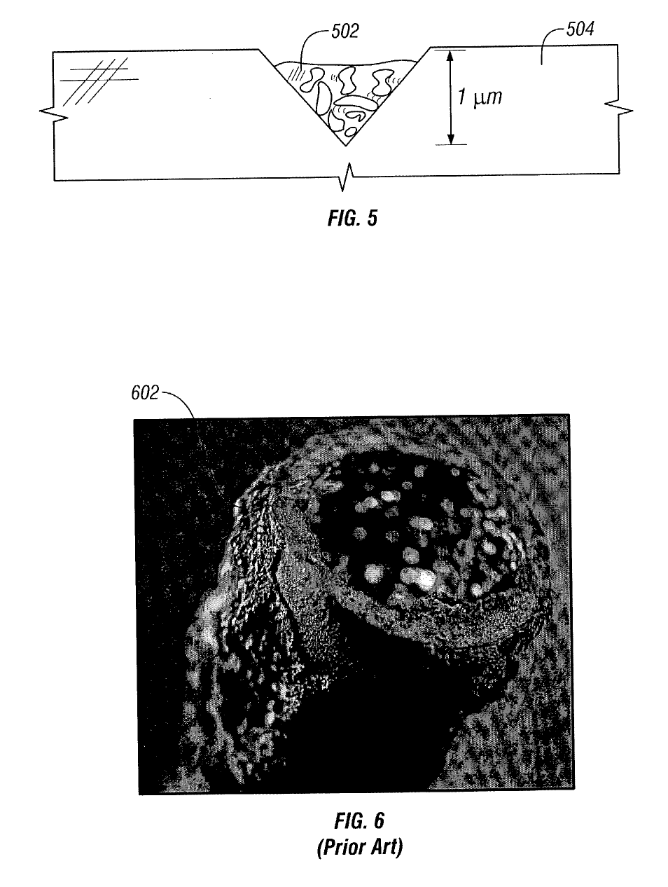

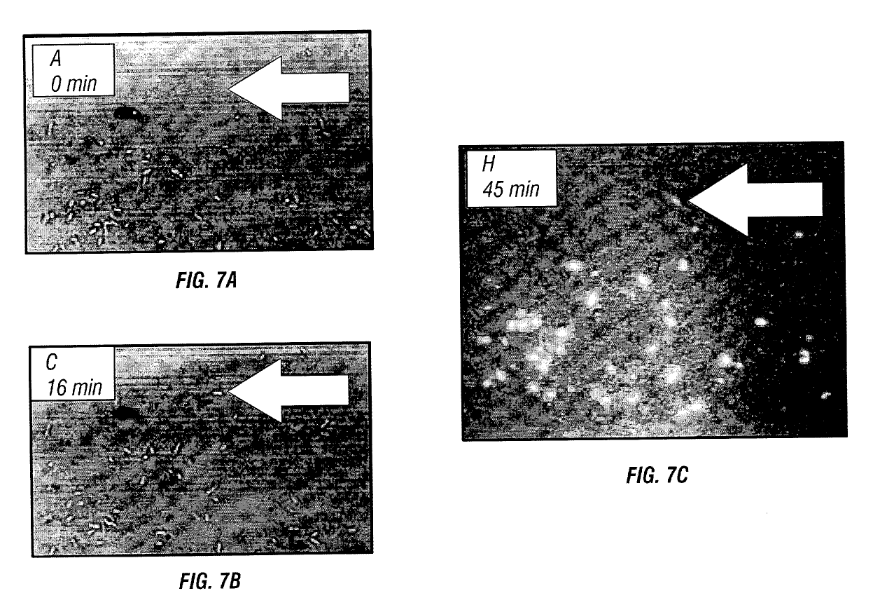

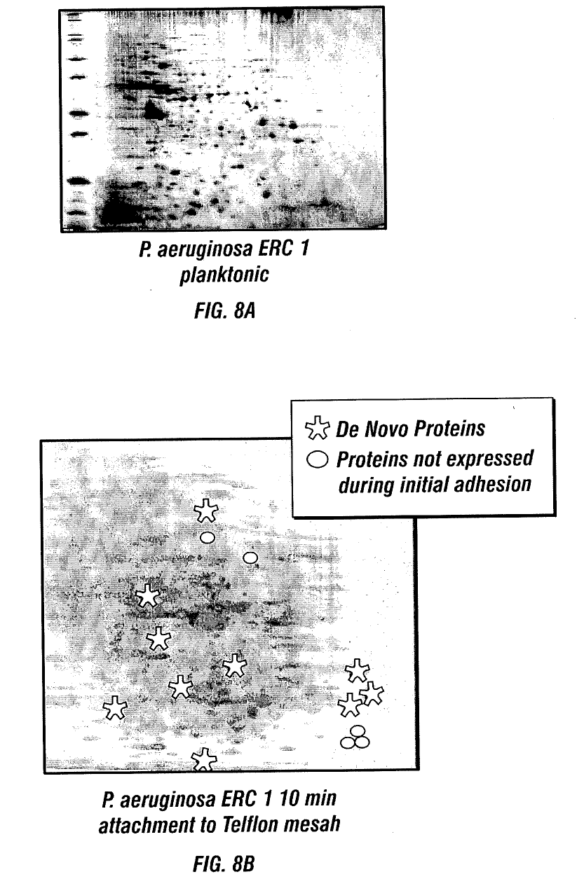

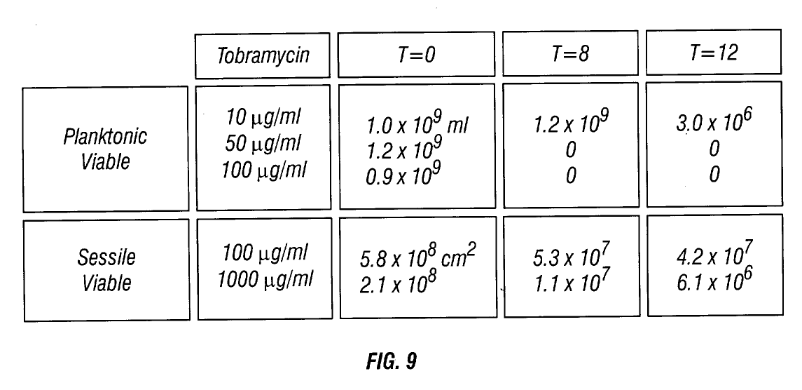

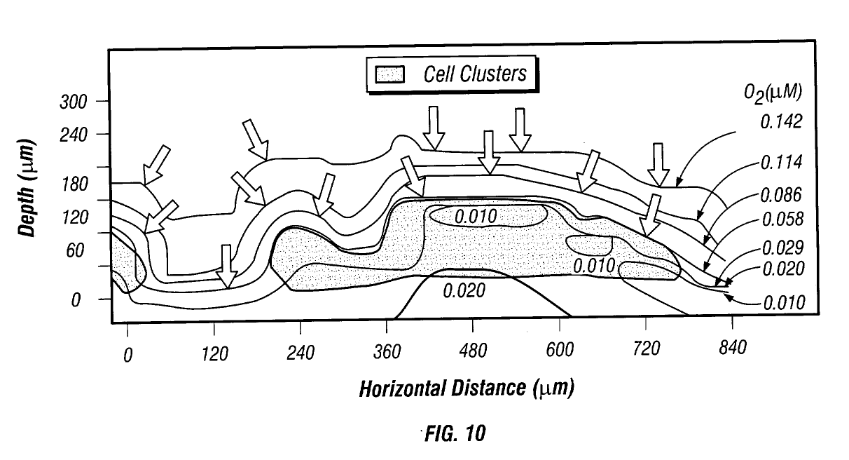

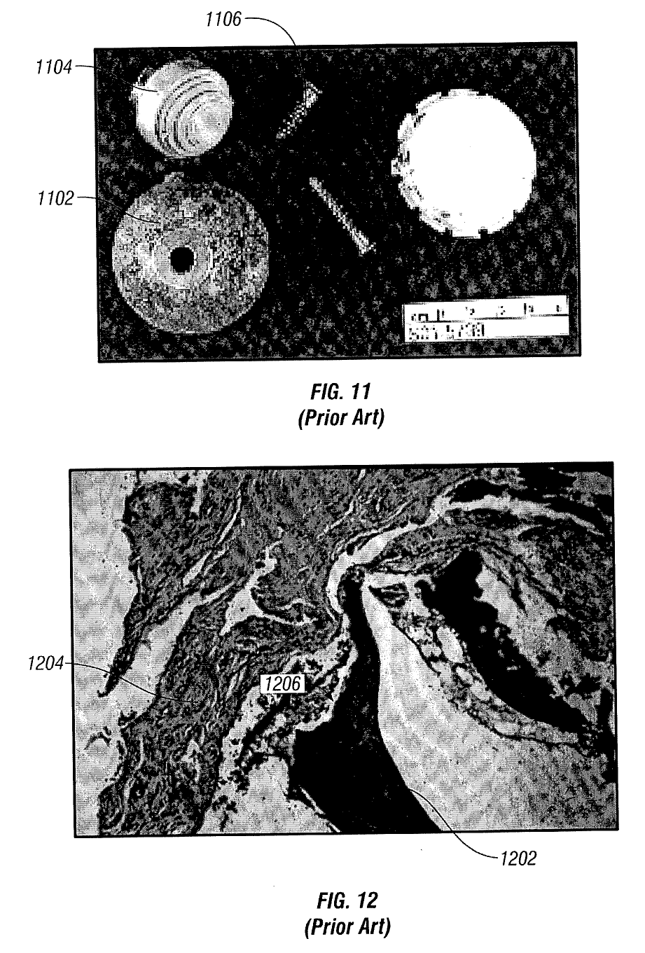

### DETAILED DESCRIPTION OF THE DRAWINGS

As discussed earlier, biofilm do not produce a classic microscopic appearance or acute inflammation unless they are dispersed in a planktonized form. Neither are they destroyed by common methods of sterilization. This makes it difficult to identify these colonies by common mechanisms such as organism culture.

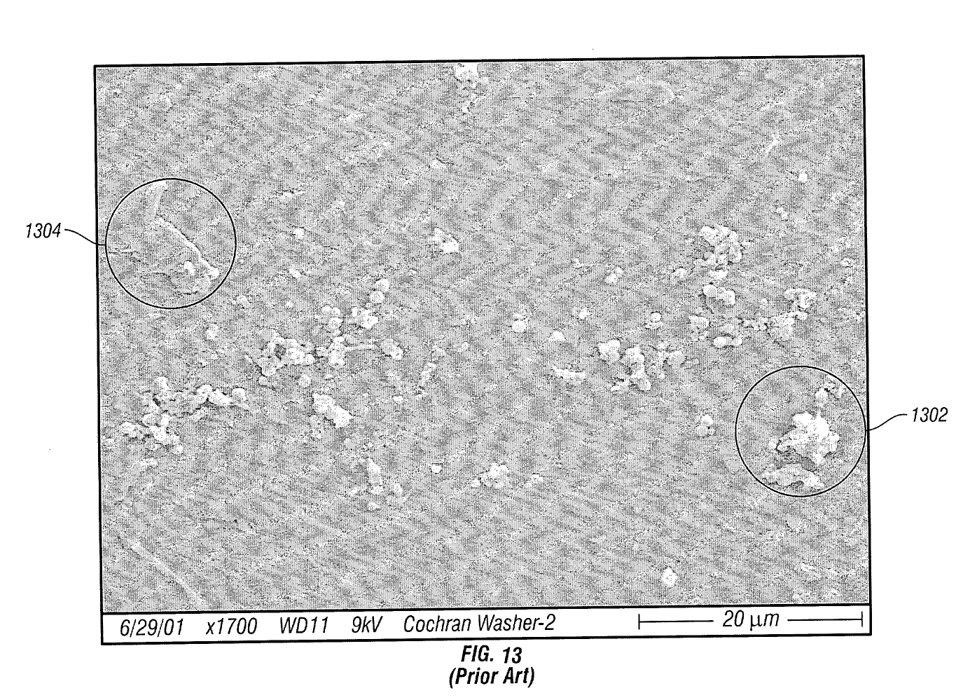

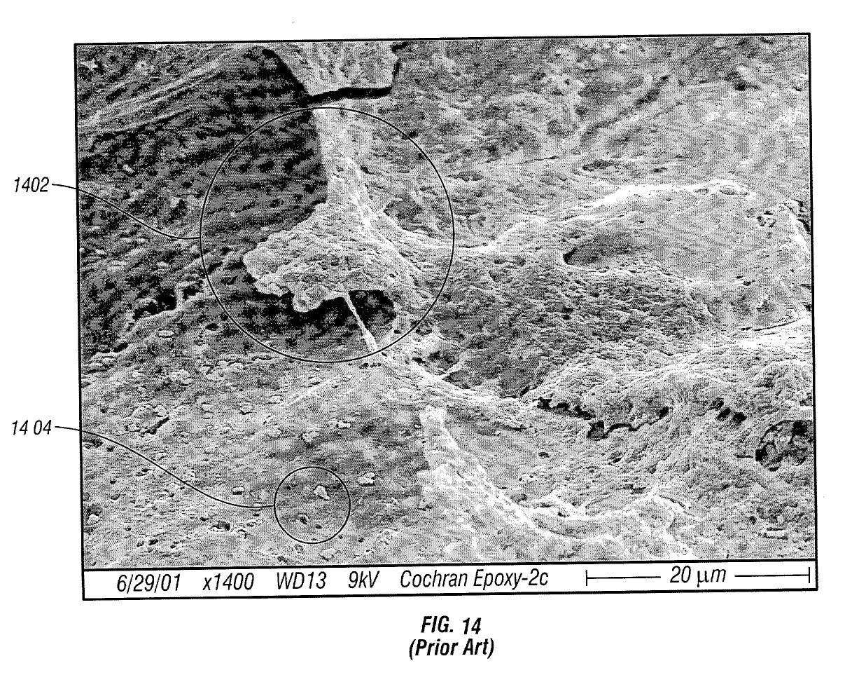

FIG. 13 shows biofilm colonies 1302, 1304 detected on a metal implant, while FIG. 14 shows a biofilm 1402 formed on the epoxy used to cement a device. Biofilm 1402 has formed a wave like pattern, a commonly seen phenomenon. The smaller colonies 1302, 1304, 1404 seen in these photographs are approximately 1 micron in size.

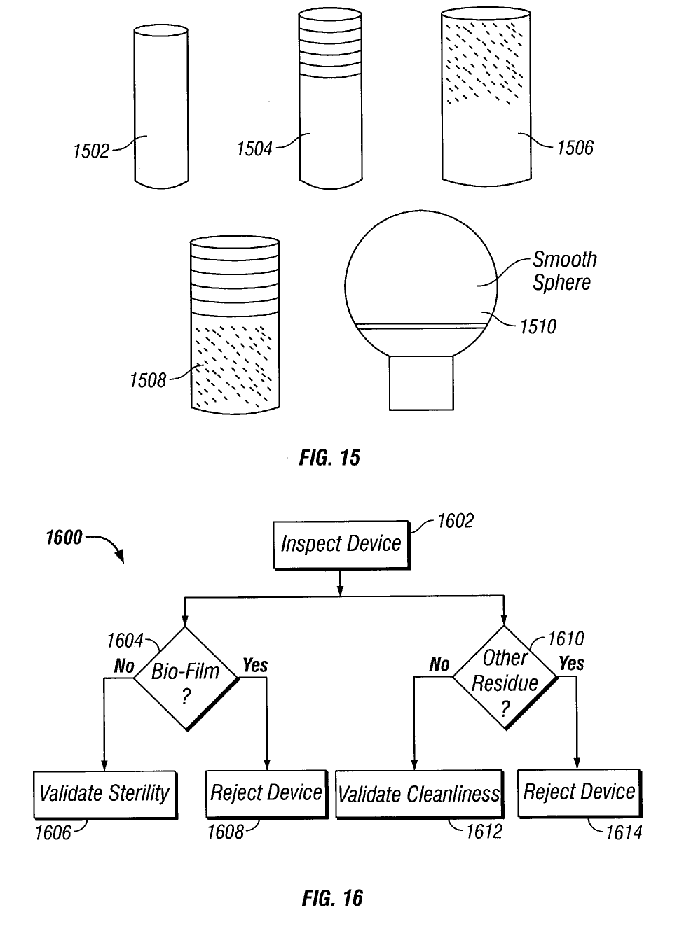

FIG. 15 is a partial illustration of various implant styles. A cylindrical pin 1502 has a smooth metallic surface. However, pin 1504 has screw threads, while pin 1506 has a textured end. Likewise, a pin 1508 could have a combination of threads and texture. Implant 1510 is a combination of a cylindrical surface and a spherical surface. While not exhaustive, these examples are provided to illustrate the difficulty of formulating a single strategy for detecting residues or biofilms.

Currently, “clean” and “sterile” have been defined in terms of planktonized bacteria only. However, as the use of manufactured items inserted into the body increases, these definitions need to be updated to reflect the understanding of biofilms and their effect on a patient's health. For medical implants, sterility must be expanded to include the absence of any biofilms on the implant. Cleanliness in implants must include an absence of both manufacturing residues (such as the oil contamination described earlier) and residues of prior biofilms, as it has been found that either of these residues can form a home for the introduction of new biofilm infections.

A first embodiment of the invention is directed to a method of certifying the sterility and cleanliness of medical implants prior to their being surgically installed in patients. Although manufacturers of implants have routinely sterilized their products, their procedures have not included any means to detect the presence of biofilms or their residues. It is recognized that it is impossible to test each and every device for biofilms, as this can be a time-consuming process. This embodiment of the invention calls for one or more devices to be collected from each lot of implantable devices produced by a manufacturer. These test devices would be shipped and stored in vacuum sealed, sterile containers, as they would for implantation. Each test device would then undergo testing as generally shown in flowchart 1600 in FIG. 16. The individual steps of inspecting the device (step 1602) are detailed below, however, the devices must be able to pass the examination for both biofilms (step 1604) and other residue (step 1610) to pass the test. If a biofilm is detected, then the device is rejected (step 1608) for sterility; if none is detected, the device is validated for sterility (step 1606). Likewise, if any residues, either from the manufacturing process or from a killed biofilm, are found, the device is rejected (step 1614); if no residue is detected, the device is validated for cleanliness (step 1612). If all test devices are certified for both sterility and cleanliness, the manufacturer is notified that the lot can be released, and that the manufacturing process has been validated. On the other hand, if either a biofilm or residues are detected, the lot will not be certified. Further steps will be taken to determine the type of bacteria, its location on the implant, and the manufacturing step at which the contamination occurred. This will give the manufacturer information necessary to prevent reoccurrences of the problem.

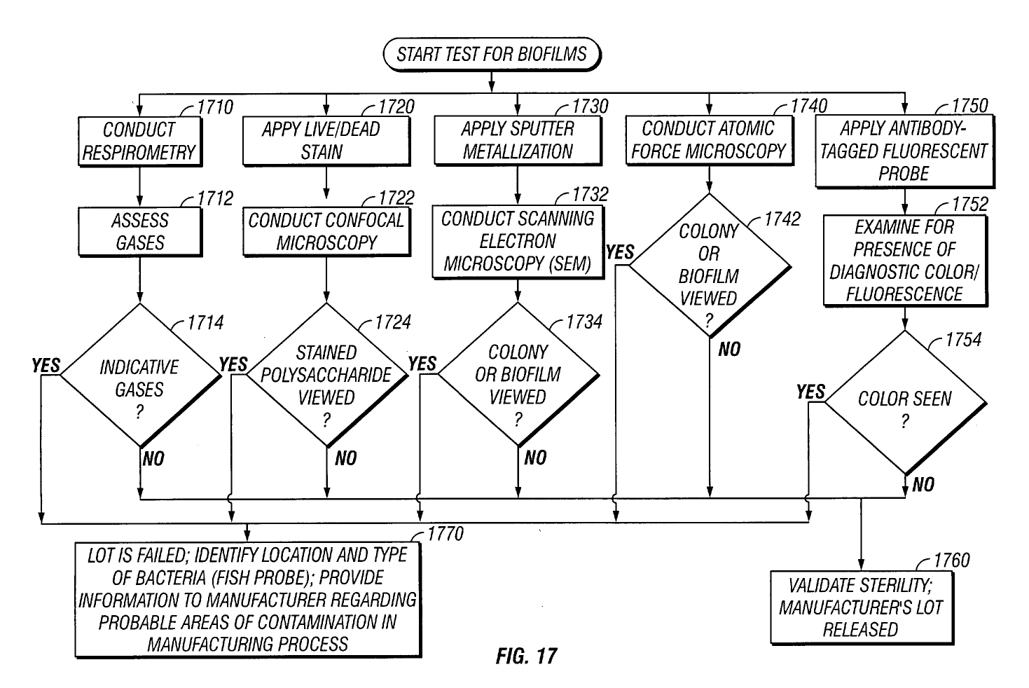

The process of testing for biofilms is detailed in flowchart 1700 in FIG. 17. Testing can follow one or more of several paths, although at least initially, each test devices will follow several of these pathways to receive certification. The pathways will be discussed with regard to this figure, with further details about the specific tests given later. In a first path, respirometry is performed (step 1710). This test provides a method of detecting the respiration of bacteria. After a given time, any gaseous byproducts from the incubation period are assessed (step 1712) for carbon dioxide and methane. The relevant question in this test is whether these indicative gases were detected (step 1714). The presence of these gases indicates living organisms; if found, the sample and its lot fail (step 1770). If these gases are not detected, then the sample and its lot can be deemed sterile (step 1760).

A second path uses confocal microscopy to visualize biofilms. In this path live/dead stains are first applied (step 1720) to the test device. These stains will, as the name suggests, stain differently for live and dead organisms. If a large area of biofilm is present on the device, it may be possible at this point to visualize it; more commonly this would require a high-powered microscope. Confocal microscopy is then performed (step 1722). The stain attaches to the polysaccharide shell of a biofilm, so the presence of a stained polysaccharide indicates a biofilm. The relevant question is then whether or not a stained polysaccharide was found (step 1724). If one is found, the sample fails (step 1770). If no polysaccharide is viewed, the device is considered sterile (step 1760).

In a third pathway, scanning electron microscopy (SEM) is performed. SEM is another high-powered visualization technique. This method requires that the surface be conductive, so the first step is to sputter a thin metallization (step 1730) onto the sample device. Once coated, the SEM can be used to scan the device (step 1732) for colonies or biofilms. The relevant question is whether bacterial colonies or biofilms are viewed (step 1734). If no biofilms are seen using SEM, the sample passes and is validated for sterility (step 1760). However, if biofilms or isolated colonies are seen, the sample fails (step 1770).

A fourth pathway for certification of sterility is through atomic force microscopy. This method uses a tiny cantilever that is moved over the surface of a sample to map its topology. This method does not require a conductive surface, nor is staining necessary. A scan of the medical device is performed (step 1740) using atomic force microscopy (AFM). Again, the relevant question is whether microbial colonies or biofilms are detected (step 1742). If no biofilms are seen using AFM, the sample passes and is validated for sterility (step 1760). However, if biofilms or isolated colonies are seen, the sample fails (step 1770).

A fifth pathway for certification of sterility is through the use of an antibody-tagged fluorescent probe being developed using the idea of ELISA—an Enzyme-Linked ImmunoSorbent Assay. As explained below, ELISA has been used to detect staphylococcus from the serum of a patient having a staphylococcus-based biofilm on a medical implant. Given this knowledge, an antibody-tagged fluorescent probe is being developed for this antigen. A surface, such as a medical implant, can be sprayed with a solution containing an antibody-tagged fluorescent probe (step 1750); after time has been allowed for any color to develop, the surface is examined for the presence of fluorescence (step 1752). Like the other pathways, the detection of biofilm causes the lot to fail (step 1770), while no detection validates the sterility (step 1760). Using this methodology, it is even possible to test medical implants at their manufacturing site or hospital surfaces, to ensure that they are free from biofilms accumulated over the lifetime of the surface.

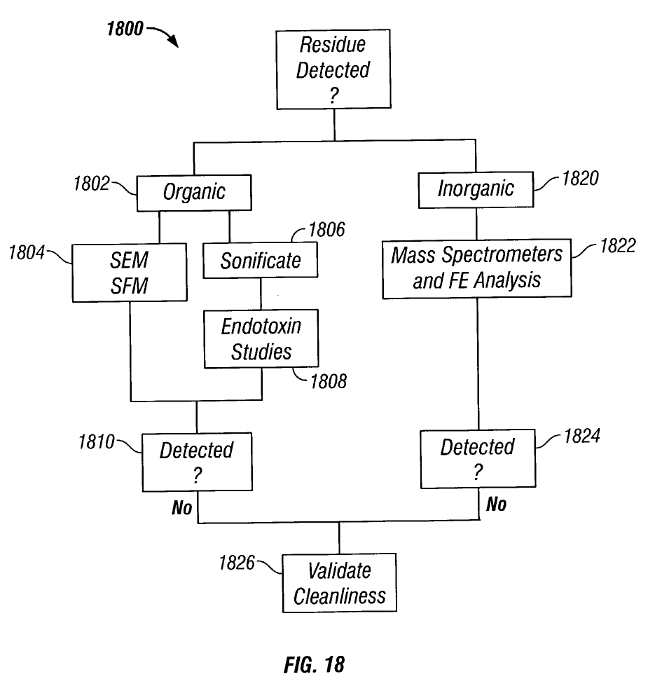

FIG. 18 shows a flowchart for the detection of residue on an implant. These residues can be artifacts from the manufacturing process, such as oil remaining after a milling process or they can be organic remnants of a previous biofilm, since it has been discovered that such organic remnants can provide a surface that is friendly to the re-establishment of a bacterial biofilm. Flowchart 1800 shows that the search for residues, like the search for biofilms, can take several routes. In the search for organic remnants (step 1802), likely steps are scanning electron microscopy (SEM) and automated scanning electron microscopy (ASEM) (step 1804). If detected, sonication (step 1806) of any debris, followed by endotoxin studies (step 1808), such as Limulus Amebocyte Lysate (LAL) assay or extracellular polysaccharides (EPS) can be performed for identification of the debris. For inorganic debris (step 1820), mass spectrometry or finite element (FE) analysis (step 1822) would be used. In either case, only if the results of both series of tests (steps 1810, 1824) returned a negative response would a certificate of cleanliness be given to the device(s) under test.

In the disclosed invention, the number of samples tested for certifying a manufacturing lot can vary, depending on the type of implant and its complexity. Only if all samples are validated for sterility and cleanliness can the entire lot be certified.

When a device fails the testing, the location of the identified biofilm or contamination is noted. A FISH Probe or a preliminary chain reaction can be used to identify specific bacteria and aid in determining the source of contamination.

In an alternate embodiment of the invention, the testing procedures described herein can also be used to detect biofilms on medical devices that have been removed from the human body, to ascertain if biofilms are responsible for failures. Alterations in the testing method can be necessary. For example, devices removed from a patient are placed in a plastic bag filled with 80% alcohol, so that the device is immersed with minimal agitation. The specimens are logged as to source, site, date, etc.

Further details of the specific tests to be run will now be discussed.

### Respirometry

Specimens of the medical devices or hardware are placed in a sterile respirometer jar with a glutamine substrate. This is a closed system, so that any gases produced by microorganisms can be detected. After incubation, the air in the respirometry jar is tested for gas produced, such as CO₂ and methane. This measurement technique has been shown to be accurate to the level of detecting 200 microorganisms. If used to detect a biofilm on a device removed from a patient, the device must be placed into the respirometry jar as soon after removal as possible.

### Confocal Microscopy

Laser Scanning Confocal Microscopy (LSCM, here referred to as confocal microscopy) is a technique that has been used effectively by researchers for the last decade to capture three-dimensional images of microscopic samples. Specimens to be imaged with a LSCM must be labelled with a fluorescent probe, such as a Live/Dead stain. This technique is similar to epifluorescence microscopy, where a light source is used to excite a fluorescent stain or fluorochrome. The excited molecule then reemits the light at a different wavelength due to internal energy loses, and this difference in wavelength is termed the Stoke's shift. The emitted light can be filtered out from the other light of the sample to allow visualization of just the stained item. Confocal microscopy has additional features that make is more effective in than simple epifluorescence for many microscopic imagining uses. The first is that laser light is used as the light source for excitation. This allows for a very small variation in wavelength, a very powerful light source and very directed and polarized light. The second major change is the use of a pinhole at the top of the microscope. This pinhole reduces the light detected by the instrument and limits it to just a small, in-focus, point of light. The computer connected to the instrument then drives a mechanical stage or lens system to scan through the sample, and then reconstructs the multiple points of captured light into a single image. This not only allows for the production of three-dimensional images by scanning plans at multiple depths, but also provides a much clearer image. This technique is very beneficial when examining something with the depth of a biofilm.

In testing the implant devices discussed above using confocal microscopy, two methods can be used. The implant device itself can be stained and mounted in relation to the laser scanning confocal microscope. Alternatively, scrapings can be taken from the device; these scrapings can be stained and mounted on glass slides in a sterile water, saline solution, or specialty microscope mounting oils The slides are placed on a confocal microscope, such as the Leica (TCS NT, Leica Microsystems Inc., Exton, Pa.) confocal microscope. This microscope is equipped with 488 nm, 568 n, and 633 nm lasers.

Samples are initially examined by use of illumination with a mercury lamp. The appropriate filter set is chosen for the stain used and the sample is examined by use of the ocular lens. This allows direct observation of the sample, which can be rapidly scanned to observe the presence and location of any flurorescence. If bacteria are found the setting on the microscope are switched to allow image capture. The appropriate laser and filter set are chosen for the stain used (for most of the FISH probes the 488 nm laser is used with the FITC or CY3 filter sets, green and red respectively). The computer and microscope are set with location of the top and bottom of the image and scanning is started. The system images the sample after which the image is saved for further analysis. Multiple images are captured of each sample, usually between 3 and 10 images, depending on the sample.

From the confocal images, thickness of the biofilm can be measure in μm. The images can be presented in a number of formats to show side, top, and 3 dimensional views of the sample. Additionally, SCION Image (Scion Corp., Frederick, Md.) analysis software can be used to determine number of cells and amount of biofilm coverage.

### FISH Probing

Fluorescence-in-situ-hybridization (FISH) probes have been used extensively for the study of microbial communities in a variety of environments. For example, Poulsen et al. (1993) used FISH probes to quantify the cellular content of ribosomes in relation to growth rate of sulfate-reducing bacteria in a multi-species biofilm. In another application, 16S rRNA-targeted probes were used to analyze the structure and function of nitrifying bacteria within biofilm communities. Slightly more recent studies have employed 16S rRNA-targeted probes to assess the distribution of lake populations of bacterioplankton (Ovreas et.al., 1997) and the seasonal and spatial variability of bacterial and archacal communities in costal ocean (Murray et.al., 1998) and high mountain lake environments (Alfreider et. al. 1996).

Application of molecular genetic techniques in studying microbial communities relevant to health and medical issues has also recently increased. For example, the direct examination of vaginal epithelial cells identified firmly adherent bacterial populations that may represent normal microflora that control the pathogenesis of vaginal infections. As in the case of any unique microbial environment, molecular techniques can be used to identify the bacterial species present, the numbers of a specified category or species bacterial, and the structural and functional organization of the overall community.

In the present invention, the probes are not used to detect the presence of a biofilm, but are used if a biofilm is detected, to help determine the species present in the biofilm. The probes are received from Integrated DNA Technologies, Inc. (Coralville, Iowa) as a lyophilized powder. The probes are immediately diluted to 1 mg/ml in sterile filtered deionized water. Aliquots of 2.5 uL are then placed into micro-centrifuge tubes and stored a t-20 degrees C. The day of use, a probe aliquot is removed from the freezer and diluted to a working concentration of 50 ng/uL by adding 47.5 uL of sterile filtered deionized water and gently mixing. The unused probe can be refrozen, but is not recommended because the probe signal tends to decrease significantly after repeat freeze/thaw cycles. A ratio of 1:8 probe of hybridization buffer is maintained. The probes used in these experiments are an EUB338-FITC or an EUB338-CY3, were the colors of fluorescence are green and red, respectively. The eubacterial probe, EUB338, has been shown in previous studies by the Center for Biofilm Engineering, and other researchers, to be specific for numerous bacterial species.

In the instant application, once a biofilm has been detected, either the orthopedic devices are placed directly into sterile deionized water or scrapings of the area of the biofilm are taken and the scrapings are placed into sterile deionized water.

Samples are removed from the sterile filtered deionized water and transferred twice to 500 uL of sterile filtered deionized water, briefly mixed, and allowed to soak for 5 minutes to remove residual enzyme. The filtered water is then transferred to 48 uL of hybridization buffer (40% formaldehyde stringency) containing 6 uL of EUB338-FITC or 6 uL of EUB338-CY3. The probes are allowed to hybridize for 2.5 hours at 46 degrees C. in a heated water bath. Following hybridization the samples are quickly transferred into microcentrifuge tubes containing 500 uL of 46° C. washing buffer at 40% stringency (using 5 M NaCl rather than formaldehyde) and incubated for 30 minutes at 46° C. to remove unbound probe. Residual salts are removed by transferring the samples twice into room temperature sterile filtered deionized water for 5 minutes. Samples are placed on a glass slide and allowed to air dry. Component C (mounting oil) from Molecular Probes LIVE/DEAD BacLight bacterial viability kit is added to the sample prior to analysis. Prolong Antifade is not used on the samples because it tended to amplify the autofluorescence of debris and fiber.

### SEM Methods

Scanning electron microscopy (SEM) is a technique that has been useful for examining bacteria on an explanted, or removed, medical sample. This technique can be used to examine biofilm growth on implants and tissues such as eukaryotic cells. In SEM, samples are bombarded with electrons; the electrons bounce back and a diode array detector measures the amounts of electrons reflected from the surface to generate an image. The bombardment with electrons requires that the surface be conductive. Additionally, the transmission of electron through space requires a low air/high vacuum environment. For these reasons, the samples must be dehydrated in a manner that does not cause them to shrivel and coated with a thin layer of conductive material. The benefits of SEM are the high resolution at high magnifications (up to 200,000x) and that the images generated have the same appearance as optically generated image.

For example, small samples (such as washers or portions for the surface coating) can be taken from the clinical hardware specimens and sent to a biofilm center. These samples are then dehydrated by successive 20-minute washes in 25%, 50% and 75% aqueous ethanol. The dehydrated samples are mounted on aluminum SEM mounts by use carbon tape. The mounted samples are sputter coated with a 15 nm coating of Au-Pd. The coating device is operated at 80 millTorr. Following coating the samples are transferred to a JEOL Model 6100 scanning electron microscope (SEM). Imaging is then conducted at 2×10⁻⁶ Torr at magnifications of 3000 to 6000 times normal. Images were recorded using Rontec MultiImage digital capture software.

In one example, seven explanted medical samples, acetabular cups, have been examined by SEM and confocal. All cups demonstrate the presence of bacterial biofilms with each of the methodologies. For example the implant screws securing the implant and cement encasing one of the cups were positive for the biofilm. All cases examined by H&E histology to determine the failure had the same appearance of oil residual described previously. However, all were culture negative. The positive biofilm found in acetabular cups with cement around the machined surfaces (not allowing for oil dispersement to surround bone tissues) are strong arguments for the bacterial biofilm as the mediator of failure in the oil contaminated acetabular prosthesis. Although the cups are contaminated with oil that could impede the sterilization procedure, acquired biofilm or infection could occur after implantation of these devices as histiocytic mediated immunity could be compromised as a result of the oil. This histiocytic mediated immunity is the major human defense mechanism for interaction with biofilm.

### Atomic Force Microscopy

The principles of atomic force microscopy (AFM) works are very simple. An atomically sharp tip is scanned over a surface with feedback mechanisms that enable the piezo-electric scanners to maintain the tip at a constant force above the sample surface. Tips are typically made from Si₃N₄ or Si, and extended down from the end of a cantilever. The nanoscope AFM head employs an optical detection system in which the tip is attached to the underside of a reflective cantilever. A diode laser is focused onto the back of a reflective cantilever. As the tip scans the surface of the sample, moving up and down with the contour of the surface, the laser beam is deflected off the attached cantilever into a dual element photodiode. The photodetector measures the difference in light intensities between the upper and lower photodetectors, and then converts to voltage. Feedback from the photodiode difference signal, through software control from the computer, enables the tip to maintain a constant height above the sample. Depending on the AFM design, scanners are used to translate either the sample under the cantilever or the cantilever over the sample. By scanning in either way, the local height of the sample is measured. Three dimensional topographical maps of the surface are then constructed by plotting the local sample height versus horizontal probe tip position. Three modes can be used in atomic force microscopy: contact mode, where the tip scans the sample in close contact with the surface, non-contact mode, where the tip hovers 50-150 Angstrom above the sample surface, and tapping mode, where imaging is implemented by oscillating the cantilever assembly at or near the cantilever's resonant frequency using a piezoelectric crystal.

In contact mode, the force on the tip is repulsive with a mean value of 10⁻⁹ N. This force is set by pushing the cantilever against the sample surface with a piezoelectric positioning element. The deflection of the cantilever is sensed and compared in a DC feedback amplifier to some desired value of deflection. If the measured deflection is different from the desired value the feedback amplifier applies a voltage to the piezo to raise or lower the sample relative to the cantilever to restore the desired value of deflection. The voltage that the feedback amplifier applies to the piezo is a measure of the height of features on the sample surface.

In non-contact mode, attractive Van der Waals forces acting between the tip and the sample are detected, and topographic images are constructed by scanning the tip above the surface. Unfortunately the attractive forces from the sample are substantially weaker than the forces used by contact mode. Therefore the tip must be given a small oscillation so that AC detection methods can be used to detect the small forces between the tip and the sample by measuring the change in amplitude, phase, or frequency of the oscillating cantilever in response to force gradients from the sample.

Tapping mode overcomes problems associated with friction, adhesion, electrostatic forces, and other difficulties that an plague conventional AFM scanning methods by alternately placing the tip in contact with the surface to provide high resolution and then lifting the tip off the surface to avoid dragging the tip across the surface. During scanning, the vertically oscillating tip alternately contacts the surface and lifts off, generally at a frequency of 50,000 to 500,000 cycles per second. As the oscillating cantilever begins to intermittently contact the surface, the cantilever oscillation is necessarily reduced due to energy loss caused by the tip contacting the surface. The reduction in oscillation amplitude is used to identify and measure surface features.

### ELISA

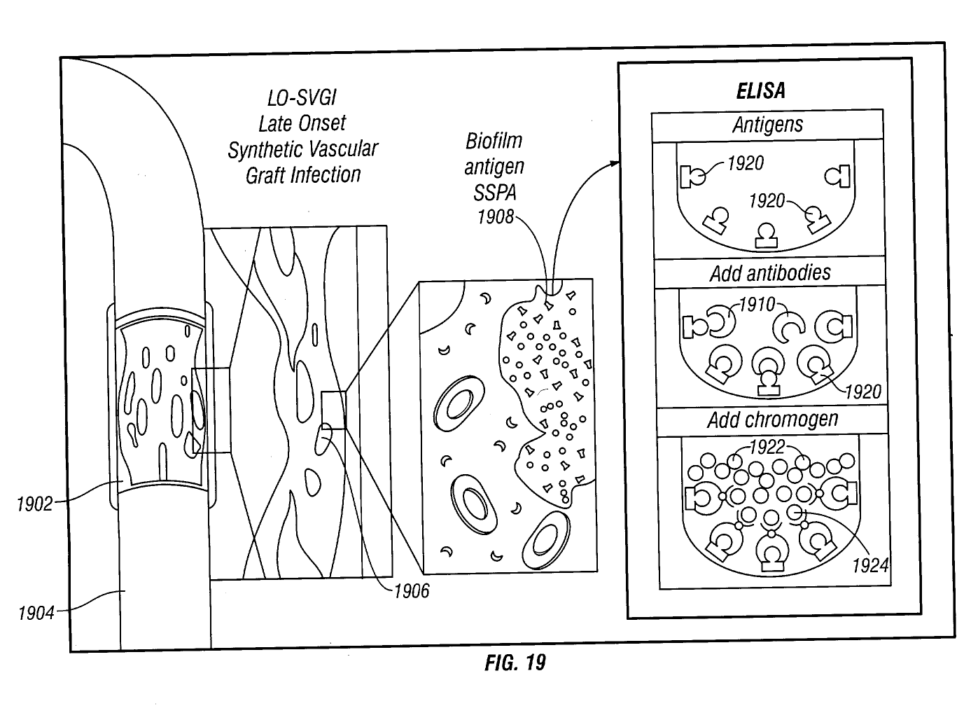

ELISA (Enzyme-Linked ImmunoSorbent Assay) is an immunological assay that can be used to qualitatively and quantitatively measure antigen-antibody binding. Depending on the variation used, it will detect an antigen or antibody in body fluids or tissue culture supernatents. The test is very specific for an antigen/antibody pair, so the repertoire of ELISA tests grows as more antigen/antibody pairs are discovered. An exemplary ELISA test will now be explained with reference to the right-hand section of FIG. 19. In the test, a plate or tube is coated with the specific antigen 1920 for a suspected infectious agent. A sample of serum taken from the patient is then added to the ELISA plate. If antibodies 1910 are present in the fluid, they will bind to the antigens 1920 and remain when other components of the fluid are washed away. After the serum has been removed, leaving only any bound antigen/antibody pairs, a chromogenic substance 1922 is added to the plate. The chromogenic substance is colorless in its free form 1922, but when it binds to an antibody, it is converted to a colored substance 1924. The amount of antibody present in the sample is reflected in the amount of color produced. The ELISA is probably the most commonly used immunological assay because of its versatility, sensitivity (it can detect very small amounts of antigen or antibody) and its specificity (it can discriminate between closely related but antigenically different molecules.

In the inventive method, this technique can also be used for detecting biofilm from the serum of patients with suspected problems. Used in this way, the technique has many distinct advantages. It can be used to discern real failures from fictitious ones. It can be serially utilized to assess whether or not it is present after surgical treatment, and can be used to assess potential benefits of therapy. With the synthetic production of antibody to the polysaccharide specific antigen, the identification of biofilm may be done at less cost than above-mentioned studies.

As an example, the left side of FIG. 19 shows a synthetic vascular graft 1902 that has replaced a portion of a blood vessel 1904. An infection has developed in the graft and a biofilm 1906 is present. The bacteria in the biofilm 1906 contain antigens 1908, a protein or carbohydrate substance capable of stimulating an immune response. In response to the presence of the antigens 1908, the body will form antibodies 1910 designed to fight the infection. Because the biofilm contains a large amount of polysaccharides, the antibodies may not be effective against the biofilm, but their presence is indicative of an infection. To test for the presence of these antibodies, a sample of fluid is taken near the site and an ELISA test performed using the suspected antigen as described above.

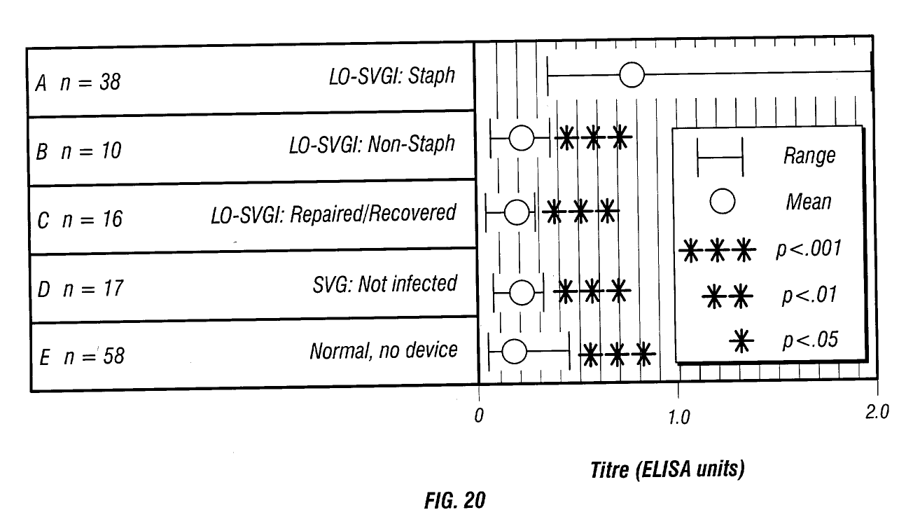

FIG. 20 shows the results from a study of a used with patients having suspected Late Onset Synthetic Graft Infection and control patients having no graft. Control patients (E), having no implanted device, show a low titre for the staphylococcus antigen, as do patients who are not infected (D), patients who have recovered from a LO-SVGI infection (C), and patients having a non-staph infection (B). In patients in whom a staph infection was found, both the range and mean of the titre of staphylococcus-specific antigen is increased over that of any other group, showing that detection by this method is possible.

A monoclonal antibody to this staph-specific antigen is under study. Once that is found and an appropriate fluorescent tag developed, it will be possible to use this antibody-tagged fluorescent probe to develop a spray or series of sprays that can be used on surfaces to detect the presence of a biofilm that is staph-specific or specific to other organisms.

Although the present invention has been described in detail, those skilled in the art should understand that they can make various changes, substitutions and alterations herein without departing from the spirit and scope of the invention in its broadest form.

1. A method of verifying a sterility of a medical implant, the method comprising the steps of:
(a) receiving at least one sterilized medical implant from a group of sterilized medical implants produced by a manufacturer;
(b) performing, on said at least one medical implant, a procedure chosen from the group consisting of confocal microscopy, scanning electron microscopy, atomic force microscopy, adding an antibody-tagged fluorescent probe, respirometry, and equivalent visualization techniques to produce test results;
(c) analyzing said test results for the presence of bacterial biofilm;
(d) if said test results indicate no evidence of bacterial biofilm, validating the sterility of the manufacturing process for said group of medical implant;
(e) if said test results indicate evidence of bacterial biofilm, providing information regarding said test results to the manufacturer for correction of the manufacturing process.

2. The method of claim 1, wherein step (b) comprises performing confocal microscopy and step (c) comprises visually identifying any biofilm or bacterial colonies in an image produced by said confocal microscopy.

3. The method of claim 2, further comprising applying a live/dead stain to the implant prior to performing confocal microscopy.

4. The method of claim 1, wherein step (b) comprises adding an antibody-tagged fluorescent probe and step (c) comprises visually identifying a developed color.

5. The method of claim 1, wherein step (b) comprises performing scanning electron microscopy and step (c) comprises visually identifying a biofilm or bacterial colony in an image produced by said scanning electron microscopy.

6. The method of claim 5, further comprising applying a sputter coating prior to said scanning electron microscopy.

7. The method of claim 1, wherein step (b) comprises performing respirometry and step (c) comprises detecting an increase in carbon dioxide or methane.

8. The method of claim 1, wherein step (e) comprises identifying a location where a biofilm has been found.

9. The method of claim 1, wherein step (e) comprises identifying a predominant bacteria found in said biofilm.

10. The method of claim 1, wherein step (e) comprises identifying a manufacturing process likely to have caused said biofilm.

11. A method of testing a removed medical implant for the presence of a biofilm, the comprising the steps of:
(a) receiving a medical implant that has been removed from a patient;
(b) performing, on said medical implant, a procedure chosen from the group consisting of confocal microscopy, scanning electron microscopy, atomic force microscopy, adding an antibody-tagged fluorescent probe, respirometry, and equivalent visualization techniques to produce test results;
(c) analyzing said test results for the presence of bacterial biofilm;
(d) if said test results indicate no evidence of bacterial biofilm, certifying a lack of biofilm; and
(e) if said test results indicate evidence of bacterial biofilm, providing information regarding said test results.

12. The method of claim 11, wherein step (b) comprises confocal microscopy and step (c) comprises visually identifying a biofilm or bacterial colony in an image produced by said confocal microscopy.

13. The method of claim 11, further comprising applying a live/dead stain to the implant prior to performing confocal microscopy.

14. The method of claim 11, wherein step (b) comprises adding an antibody-tagged fluorescent probe and step (c) comprises detecting a developed color.

15. The method of claim 11, wherein step (b) comprises scanning electron microscopy and step (c) comprises visually identifying a biofilm or bacterial colony in an image produced by said scanning electron microscopy.

16. The method of claim 11, wherein step (b) comprises respirometry and step (c) comprises detecting an increase in carbon dioxide or methane.

17. The method of claim 11, wherein step (e) comprises identifying a location where a biofilm has been found.

18. The method of claim 11, wherein step (e) comprises identifying a predominant bacteria found in said biofilm.
